(19) United States
(12) Patent Application Publication
(10) Pub. No.: US 2015/0369401 A1
(43) Pub. Date: Dec. 24, 2015

(54) LEAK-RESISTANT SOLAR PANEL CONNECTOR

(71) Applicant: Aquatherm Industries, Inc., Lakewood, NJ (US)

(72) Inventor: J. David SIZELOVE, Brick, NJ (US)

(73) Assignee: Aquatherm Industries, Inc., Lakewood, NJ (US)

(21) Appl. No.: 14/308,432

(22) Filed: Jun. 18, 2014

(51) Int. Cl. F16L 11/12

(52) U.S. Cl. CPC F16L 11/122

(57) ABSTRACT

A non-reinforced solar panel connector having a tubular shape with a central lumen, a central section of relatively high hardness in relation to terminal sections of relatively low hardness, a length which does not exceed five times its diameter, and whose central section includes a projection partially extending into the lumen, with the projection being substantially perpendicular to a longitudinal axis of the connector. The connector is preferably molded from EPDM rubber. The relatively soft terminal sections may be used to easily and reliably join a solar panel to another solar panel and to associated piping in fluid-tight relationship, while the relatively hard central section ensures the connector does not expand or contract excessively.

The present invention is directed to a leak-resistant connector for a solar heating apparatus. More particularly, the present invention relates to a solar panel connector which has improved sealing properties in comparison to a conventional continuously extruded unreinforced hose of a single durometer or a reinforced hose made from multiple wrappings of rubber and a reinforcing cord or filament

### BACKGROUND OF THE INVENTION

A solar panel typically includes a plurality of relatively small diameter hollow tubes whose opposite ends are connected to an intake manifold and an exhaust manifold, respectively. U.S. Pat. Nos. 6,787,116; 7,112,297, and 7,634,994, each of which is incorporated herein in its entirety, disclose improved solar panels.

A working fluid, typically water, is pumped via associated piping to the solar panel, warmed by sunlight, and returned via associated piping to heat a desired location such as a swimming pool and/or residence. A plurality of solar panels may be connected in parallel to provide the desired amount of heating capacity.

Elastomeric hose is typically used to join solar panels to their associated piping and to one another. The hose must possess sufficient strength to withstand fluid pressure increases and decreases during solar panel operation. The pressure will increase as the fluid pumping rate is increased; the pressure will decrease when water is drained from the system and a partial vacuum is temporarily created, despite the presence of one or more vacuum relief valves in the system. The solar heating system can experience a pressure range of from 1310 to 340,000 Pascals (0.0131 to 3.40 bar).

The elastomeric hose must also possess sufficient flexibility to permit expansion and contraction over the temperature range (e.g., from 0 to 160° F.) experienced by the solar collector. Flexibility is also required to ensure a fluid-tight seal between the ends of the hose and the ends of the rigid piping and solar panel(s).

Solar panel heating systems have a service life of 15 years or more. They must retain their strength and flexibility properties over daily temperature cycles, as well as seasonal changes in weather. They must be impervious to UV degradation. In short, they must be weatherproof.

Elastomeric hose can expand and burst upon application of higher-than-atmospheric pressure and can collapse and restrict flow upon application of reduced (lower-than-atmospheric) pressure. A known solution to this problem is to increase either the hardness and/or the wall thickness of the hose. However, these modifications can make the hose difficult to seal, and therefore leakage at the pipe and/or solar panel connection may occur. Another known solution to the deformation problem is to reinforce the hose with a cord or filament which is wound around the hose, or which is incorporated into the hose wall itself. The high cost of such reinforced hose limits their use in less demanding applications. Moreover, although such reinforced hose can withstand high pressure without deformation, they can easily collapse under reduced pressure. Also, the compression set of reinforced hose can be greatly reduced. When this happens, fasteners such as a worm-gear type clamp must be tightened further, thereby further reducing the hose's ability to return to its original state. Eventually, it will be no longer possible to tighten the fastener any further and the hose connection may leak.

U.S. Pat. No. 1,928,992 discloses flexible tubing in which includes at least one continuous longitudinal internal reinforcement so as to ensure fluid passage even though the tubing is kinked, bent or trod upon.

U.S. Pat. No. 3,953,270 discloses a method for manufacturing elastomeric high pressure hose having reinforcement in the form of braided or spiral wrapped textile yarns between extruded inner and outer elastomeric layers. The method includes the steps of extruding the inner elastomeric layer over a long flexible mandrel up to about 1000 ft in length coextensively therewith, then progressively freezing portions of the layer and braiding or spiral wrapping a textile reinforcement there over. The layer is frozen to prevent extrusion of the inner layer during the braiding. Thereafter additional elastomeric and textile layers are applied and the elastomers are vulcanized in an elongated continuous vulcanizer.

U.S. Pat. No. 4,662,404 discloses flexible tubing having a set of relatively stiff sections alternating with a set of relatively flexible sections, with each flexible section having a length no greater than twice the diameter of the tubing. The alternating flexible/stiff construction is achieved by sequentially extruding plastic materials having different durometer hardness. The tubing is said to possess a sufficient degree of stiffness and rigidity to prevent collapse and to eliminate knotting and kinking when used in medical applications such as a catheter. Tubing with short flexible sections between stiff sections is said to act like an articulated rigid tube, a hinged tube, and can be sufficiently stiff so that it can be passed through a vessel or introduced into a body cavity without the necessity of using a guide-wire, stylette stents or rigid introducers.

U.S. Pat. No. 7,387,826 discloses a tubular medical device having different crystallization regions and thus different stiffness/flexibility properties along its length. The different properties can be tailored by varying the amount of a crystallization modifier present in a thermoplastic, melt processed polymer.

U.S. Published Application 2008/0011377 to Van Hooren et al. discloses a flexible charge-air hose for the automobile industry which may have several cross-linked, substantially rigid sections alternating with uncross-linked, flexible sections. The figures illustrate a hose having a flexible, uncross-linked central section separating two cross-linked, rigid end sections.

### SUMMARY OF THE INVENTION

An object of the present invention is to provide a non-reinforced solar panel connector which has improved sealing properties in comparison to known reinforced hose.

Another object of the present invention is to provide a non-reinforced solar panel connector which is resistant to expansion and compression.

In one aspect, the present invention relates to a non-reinforced solar panel connector having a tubular shape with a central lumen, said connector comprising

two opposed terminal sections, each having a Shore A hardness within the range of 65 to 75, measured according to ASTM D2240;

a central section joined to said two opposed terminal sections, said central section having a Shore A hardness in the range of 75 to 85, measured according to ASTM D2240 and having a projection which partially extends into said central lumen, said projection being substantially perpendicular to a longitudinal axis of said connector,

wherein the Shore A hardness of said central section is greater than the Shore A hardness of said terminal sections, and

wherein a length of said connector is not greater than five times its inner diameter.

### BRIEF DESCRIPTION OF THE DRAWINGS

FIG. 1 is a cross-section of a side view of a solar panel connector according to a first embodiment of the invention.

FIG. 2 is a front view of the solar panel connector of FIG. 1.

### DETAILED DESCRIPTION OF THE PREFERRED EMBODIMENTS

### A. Glossary

“Compression molding” means a molding process in which an uncured rubber or elastomeric compound is placed into an open, heated mold cavity, and compressed into its final shape by the closure of the mold.

“Compression set” means the amount of permanent deformation experienced by a rubber or elastomeric material when compressed for a period of time. The term is commonly used in reference to a test conducted under specified conditions in which the permanent deformation, expressed as a percentage of the original deflection, is measured after a prescribe period of time. A low compression set is desirable in molded parts which must maintain their dimensions to maintain an effective seal.

“Durometer” is a standard rubber industry term for hardness as well as a specific hardness measurement device known as an indenter. While other scales are available, the hardness of a rubber material is most commonly determined using a durometer indenter based on the Shore A hardness scale.

“Hardness” means the resistance to penetration of a rubber material by an indenter. High values indicate harder materials, while low values indicate softer materials.

“Injection molding” means a molding method in which a rubber or elastomeric material is heated and forced under pressure into a closed mold cavity.

“Inner diameter” means the smallest surface of a circular object.

“Lumen” means the internal, open space of a hollow tube.

“Non-reinforced solar panel connector” means the rubber or elastomeric material comprising the connector does not contain continuous fiber or staple fiber.

“Shore A hardness” is a harness value measured according to ASTM D2240 type A.

“Transfer molding” means a molding method in which material is placed in a pot located between a top plate and plunger, and forced from the pot through sprues into a closed mold cavity.

### B. Preferred Solar Panel Connector

The solar panel connector of the present invention may be made from any elastomer having the required hardness ranges, flexibility and resistance to embrittlement caused by exposure to UV radiation, heat, chlorine, chloramines and other water treatment chemicals. Suitable elastomers include EPDM rubber, a terpolymer of ethylene, propylene and a diene, ethylene propylene rubber (EPM), epichlorohydrin rubber, polyacrylic rubber, silicone rubber, fluorosilicone rubber, fluoroelastomers, perfluoroelastomers, polyether block amides, chlorosulfonated polyethylene and ethylene-vinyl acetate. Other suitable materials include thermoplastic polyolefins (TPO) and thermoplastic elastomers (TPE). TPO is a trade name that refers to polymer/filler blends usually consisting of some fraction of PP (polypropylene), PE (polyethylene), BCPP (block copolymer polypropylene) and rubber. Thermoplastic elastomers (TPE), sometimes referred to as thermoplastic rubbers, are a class of copolymers or a physical mix of polymers (usually a plastic and a rubber) which consist of materials with both thermoplastic and elastomeric properties. While most elastomers are thermosets, thermoplastics are in contrast relatively easy to use in manufacturing, for example, by injection molding. Thermoplastic elastomers show advantages typical of both rubbery materials and plastic materials. EPDM rubber is preferred due to its wide availability and low cost.

The central section of the solar panel connector is made from an elastomer having a relatively high hardness. A preferred hardness range for the central section is 75 to 85 Shore A hardness, measured according to ASTM D2240. The central section includes a projection which extends partially inward from the connector wall, but which does not block the flow of fluid through the connector. The projection provides additional strength to the central section. The relatively high hardness and projection of the central section ensure the connector does not expand or contract excessively.

The terminal ends of the connector are made from a softer elastomer in comparison to the central section so as to permit easy installation, i.e., placement of the connector ends over the collector inlet and outlet pipes and associated piping. The relatively softer elastomer allows improved sealing of the connector to the solar panel and its associated piping. A preferred hardness range for the terminal sections of the hose is 65 to 75 Shore A hardness, measured according to ASTM D2240.

The terminal sections preferably each have two circumferential ribs, each rib projecting from an external surface of the terminal section and spaced from the other rib by a distance substantially equal to or greater than the width of a worm gear clamp fastener. The ends of the solar panel and/or the ends of the associated piping may also have a barb, sealing groove or the like to assist in joining and sealing the connector.

The Shore A hardness of the central section is greater than the Shore A hardness of the terminal sections. The relatively softer and relatively harder elastomers may be prepared by employing different amounts of cross-linkable monomers, cross-linking agents and/or fillers. Suitable elastomeric resins having different degrees of cross-linking are commercially available from various manufacturers. EPDM manufacturers include Dow Chemical Company, ExxonMobil Chemical Company, LANXESS AG, Lion Copolymer Geismar, LLC and Minnesota Rubber & Plastics Quadion LLC. Thus, for example, EPDM resin having a Shore A hardness of 70 can be obtained from Minnesota Rubber & Plastics under its tradename Compound 559N, while EPDM resin having a Shore A hardness of 80 is can be obtained under its tradename Compound 560VH.

The solar panel connector's diameter and length may be varied as required to conform to the dimensions of a specific solar panel. Generally, the connector's length should be as short as possible to maximize the surface area of the solar collector(s). In practice, its length should not exceed 5×, preferably 4× and most preferably 3×, its diameter. Generally, the connector may have a length ranging from 3 to 8 inches, an outside diameter of 2 to 5 inches, and an inside diameter, measured across the internal reinforcement, of 2 to 4 inches.

Different connections may require connectors having different lengths. Thus, a panel-to-panel connector need only be 3.75 inch long. Thus, one preferred panel-to-panel connector embodiment has a length of 3.75 inches, an external diameter of 2.25 inches and an internal diameter, measured across the internal reinforcement, of 1.5 inches. In contrast, a panel-to-piping connector may require a 7 inch length to accommodate expansion and contraction of the piping.

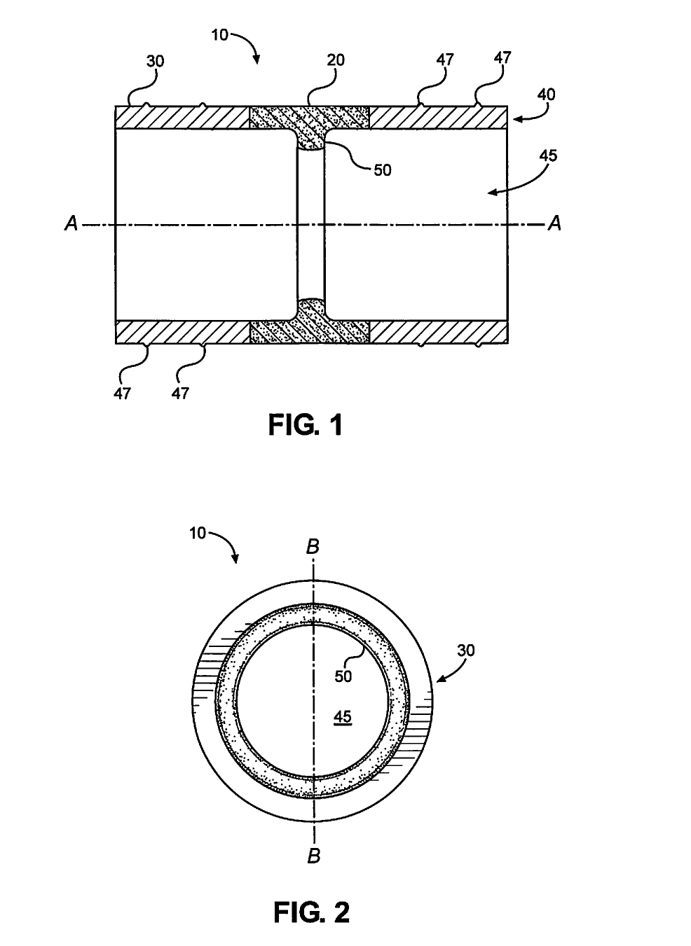

FIG. 1 is a cross-section along vertical axis B-B which illustrates solar collector connector 10 having central section 20 between opposed terminal sections 30 and 40. Lumen 45 extends along longitudinal axis A-A of connector 10. Central section 20 includes projection 50 which extends partially into lumen 45, and which is substantially perpendicular to longitudinal axis A-A. Circular ribs 47 are formed on terminal sections 30 and 40 to assist in properly locating a worm gear clamp fastener (not shown).

FIG. 2 is a front view of the solar connector 10 of FIG. 1. As best illustrated in FIG. 2, projection 50 does not substantially block lumen 45, and thus water or other fluid can pass from one end of solar connector 10 to the other.

The solar panel connector of the present invention may be manufactured utilizing high volume, inexpensive methods such as compression molding, injection molding and transfer molding, using thermosetting resins in a partially cured stage, typically in particulate form. Compression molding and injection molding are both preferred manufacturing methods.

For example, in the compression molding method, two slugs of identical EPDM resin particles are placed in the terminal portions of an appropriately dimensioned compression mold cavity, with a third slug of EPDM placed in the central mold portion. The third slug has a higher Shore A hardness than the EPDM slugs placed in the terminal portions of the mold. The mold is closed by securing the plug member in place, and heat (280-350° F.) and pressure (2,000-3,000 psi) applied until the EPDM resin slugs are melted, cross-linked and joined to one another to form the desired solar connector having well-defined central and terminal sections. The residence time in the mold can vary from 10 to 40 minutes, depending on variables such as temperature, pressure, and the number and size of the connector(s) in a particular mold.

By “well-defined” it is meant there is only a short interface between the central and terminal sections in which the elastomer transitions from one section to the other, i.e., from soft to hard and vice versa. The two interfaces may each have a length of from 0.1 to 0.5 inch and possess an intermediate hardness which is between that of the central and terminal sections.

In the injection molding embodiment, the EPDM slugs are each individually melted prior to individual injection into a closed mold cavity having the shape of the desired solar panel connector. High pressure and temperature is applied to cross-link and join the three molten polymeric masses to form the desired solar connector having well-defined central and terminal sections.

The solar panel connector may be used in the same manner as current elastomeric hose. More particularly, the solar panel and its associated piping may be prepositioned on a suitable structure such as a roof. A suitable fastener, such as a worm gear clamp fastener, is first placed over each terminal section of the solar panel connector. The connector is then forced over the solar panel inlet and the associated piping, and the worm gear clamp fasteners tightened to ensure a fluid-tight seal. Another connector is used to join the solar panel outlet with its associated piping using the same process.

The piping and solar panel are then fastened to the structure using conventional fasteners and techniques well known to those of ordinary skill in the art. U.S. Pat. No. 8,567,742, the disclosure of which is incorporated herein in its entirety, discloses an improved mounting protection device for fastening solar panels to a structure.

An advantage of the soft/hard/soft longitudinal construction of the solar panel connector is that it provides both the desired strength and improved sealing (fluid-tightness), while allowing easy installation of the connector between the inlet and outlet pipes of the solar collector and its associated piping.

Yet another advantage of the invention is the solar panel connector can impart additional structural reinforcement to a solar heating apparatus than was typically achieved by the elastomeric hose connections of the prior art.

1. A non-reinforced solar panel connector having a tubular shape with a central lumen, said connector comprising
two opposed terminal sections, each having a Shore A hardness within a range of 65 to 75 measured according to ASTM D2240;
a central section joined to said two opposed terminal sections, said central section having a Shore A hardness in a range of 75 to 85 measured according to ASTM D2240 and having a projection which partially extends into said central lumen, said projection being substantially perpendicular to a longitudinal axis of said connector,
wherein the Shore A hardness of said central section is greater than the Shore A hardness of said terminal sections, and
wherein a length of said connector is not greater than five times its inner diameter.

2. The non-reinforced solar panel connector of claim 1, wherein at least one of said central and terminal sections is made from an elastomer selected from the group consisting of EPDM, ethylene/propylene, polychloroprene, isobutylene/isoprene, epichlorohydrin, polyacrylic, silicone, fluorosilicone, fluoroelastomers, perfluoroelastomers, polyether block amides, chlorosulfonated polyethylene and ethylene-vinyl acetate.

3. The non-reinforced solar panel connector of claim 2, wherein said elastomer is EPDM.

4. The non-reinforced solar panel connector of claim 1, wherein at least one of said terminal sections has two circumferential ribs, each rib projecting from an external surface of said terminal section and spaced from the other rib by a distance substantially equal to or greater than a width of a worm gear clamp fastener.

5. The non-reinforced solar panel connector of claim 1, wherein said length of said connector is not greater than 4 times its inner diameter.

6. The non-reinforced solar panel connector of claim 5, wherein said length of said connector is not greater than 3 times its inner diameter.
